(19) United States
(12) Patent Application Publication
(10) Pub. No.: US 2018/0098258 A1
(43) Pub. Date: Apr. 5, 2018

(54) INTER-RAT MOBILITY MEASUREMENTS AND OPERATIONS TO SUPPORT UE CONNECTIVITY

(71) Applicant: QUALCOMM Incorporated, San Diego, CA (US)

(72) Inventors: Raevanth Venkat Annam, Hyderabad (IN); Chinmaya Padhy, Hyderabad (IN); Pankaj Gupta, Hyderabad (IN); Naveen Kumar Hanchate, Hyderabad (IN); Rajdeep Mukherjee, Hyderabad (IN)

(21) Appl. No.: 15/283,630

(22) Filed: Oct. 3, 2016

(51) Int. Cl. H04W 36/24; H04W 4/02; H04W 24/10; H04W 36/30; H04W 36/00; H04B 17/318; H04B 17/336; H04W 36/14

(52) U.S. Cl. CPC H04W 36/245; H04W 4/02; H04W 24/10; H04W 36/14; H04W 36/0061; H04B 17/318; H04B 17/336; H04W 36/30

(57) ABSTRACT

Methods, systems, and devices for wireless communication are described. To avoid radio link failure (RLF) events for user equipment (UEs) in areas determined to have less reliable cellular communications coverage, a UE may adjust transmission of and timing for certain types of wireless communication messages, including those with measurement reports. For example, based on measurements made by a UE, the UE may modify thresholds for mobility procedure-triggering events, which may cause an inter-radio access technology (RAT) handover event to occur earlier than normal. A UE may, for example, receive and measure signals, and it may determine that a Long Term Evolution (LTE) serving cell or an LTE coverage area offers unreliable coverage. The UE may modify its operations to cause an early trigger of an inter-RAT handover event. The UE may switch to a network operating according to a different RAT before experiencing an RLF on the LTE network.

### BACKGROUND

The following relates generally to methods implemented by a user equipment (UE) in a wireless communication system and more specifically to inter-rat mobility measurements and operations to support UE connectivity.

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communication system may include a number of base stations, each simultaneously supporting communication for multiple communication devices, which may be otherwise known as user equipment.

In some wireless communication networks, coverage areas of communication links that use a first radio access technology may not be coextensive with coverage areas of communication links that use a second radio access technology. For example, at a particular location, a UE may have better connectivity to a network using a 2G or 3G radio access technology (e.g., Universal Mobile Telecommunications System (UMTS), CDMA2000, Global System for Mobile Communications (GSM), etc.) rather than using an LTE radio access technology, but the UE may be unable to efficiently move to a network employing a 2G or 3G RAT if the UE is configured for LTE.

### SUMMARY

The described techniques relate to improved methods, systems, devices, or apparatuses that support inter-RAT mobility measurements and operations to support UE connectivity. A UE may modify thresholds for mobility procedure-triggering events, which may cause an inter-RAT handover event to occur earlier than normal. A UE may, for example, receive and measure signals, and it may determine that a LTE serving cell or an LTE coverage area offers unreliable coverage. The UE may modify its operations to cause an early trigger of an inter-RAT handover event. The UE may switch to a network operating according to a different RAT before experiencing an RLF on the LTE network.

A method of a wireless communication is described. The method may include measuring a signal strength of a serving cell that is operating according to a first radio access technology (RAT), determining, based at least in part on the signal strength satisfying a first threshold, that an identifier associated with the serving cell is on a list of cells for which at least one prior measurement procedure has failed and a radio link failure (RLF) condition resulted, modifying a second threshold based at least in part on determining that the identifier associated with the serving cell is on the list, wherein the second threshold is different from the first threshold, and transmitting a measurement report to a base station for the serving cell based at least in part on determining that the signal strength of the serving cell satisfies the second threshold for a predetermined time period.

An apparatus, such as a user equipment (UE) in a wireless communication system is described. The apparatus may include means for measuring a signal strength of a serving cell that is operating according to a first radio access technology (RAT), means for determining, based at least in part on the signal strength satisfying a first threshold, that an identifier associated with the serving cell is on a list of cells for which at least one prior measurement procedure has failed and a radio link failure (RLF) condition resulted, means for modifying a second threshold based at least in part on determining that the identifier associated with the serving cell is on the list, wherein the second threshold is different from the first threshold, and means for transmitting a measurement report to a base station for the serving cell based at least in part on determining that the signal strength of the serving cell satisfies the second threshold for a predetermined time period.

Another apparatus, such as a user equipment (UE) in a wireless communication system is described. The apparatus may include a processor, memory in electronic communication with the processor, and instructions stored in the memory. The instructions may be operable, when executed by the processor, to cause the apparatus to measure a signal strength of a serving cell that is operating according to a first radio access technology (RAT), determine, based at least in part on the signal strength satisfying a first threshold, that an identifier associated with the serving cell is on a list of cells for which at least one prior measurement procedure has failed and a radio link failure (RLF) condition resulted, modify a second threshold based at least in part on determining that the identifier associated with the serving cell is on the list, wherein the second threshold is different from the first threshold, and transmit a measurement report to a base station for the serving cell based at least in part on determining that the signal strength of the serving cell satisfies the second threshold for a predetermined time period.

A non-transitory computer-readable medium for wireless communication is described. The non-transitory computer-readable medium may include instructions executable to measure a signal strength of a serving cell that is operating according to a first radio access technology (RAT), determine, based at least in part on the signal strength satisfying a first threshold, that an identifier associated with the serving cell is on a list of cells for which at least one prior measurement procedure has failed and a radio link failure (RLF) condition resulted, modify a second threshold based at least in part on determining that the identifier associated with the serving cell is on the list, wherein the second threshold is different from the first threshold, and transmit a measurement report to a base station for the serving cell based at least in part on determining that the signal strength of the serving cell satisfies the second threshold for a predetermined time period.

Some examples of the method, apparatus, and non-transitory computer-readable medium described above may further include processes, features, means, or instructions for identifying a location of the UE. Some examples of the method, apparatus, and non-transitory computer-readable medium described above may further include processes, features, means, or instructions for modifying the second threshold based at least in part on the location of a UE.

Some examples of the method, apparatus, and non-transitory computer-readable medium described above may further include processes, features, means, or instructions for comparing the location of the UE to a location of a past RLF event associated with the serving cell, wherein the location of the past RLF event may be included on the list.

Some examples of the method, apparatus, and non-transitory computer-readable medium described above may further include processes, features, means, or instructions for measuring a signal strength of a neighboring cell operating according to a second RAT that may be different from the first RAT.

In some examples of the method, apparatus, and non-transitory computer-readable medium described above, the second threshold may be associated with an inter-RAT handover event between the serving cell and the neighboring cell.

Some examples of the method, apparatus, and non-transitory computer-readable medium described above may further include processes, features, means, or instructions for determining that the signal strength of the serving cell may be below the second threshold for the predetermined time period. Some examples of the method, apparatus, and non-transitory computer-readable medium described above may further include processes, features, means, or instructions for determining that the signal strength of the neighboring cell may be above a third threshold for the predetermined time period.

In some examples of the method, apparatus, and non-transitory computer-readable medium described above, modifying the second threshold further comprises: adjusting a value of the second threshold, wherein the value of the second threshold may be less than a value of the first threshold. Some examples of the method, apparatus, and non-transitory computer-readable medium described above may further include processes, features, means, or instructions for adjusting a value of a third threshold associated with the signal strength of the neighboring cell.

In some examples of the method, apparatus, and non-transitory computer-readable medium described above, modifying the second threshold further comprises: adjusting the second threshold according to an offset based at least in part on information included in the list associated with the identifier of the serving cell.

In some examples of the method, apparatus, and non-transitory computer-readable medium described above, the offset may be determined based at least in part on information included on the list related to a previous RLF event associated with the serving cell.

Some examples of the method, apparatus, and non-transitory computer-readable medium described above may further include processes, features, means, or instructions for transmitting an indication to the base station that the serving cell may be on the list.

Some examples of the method, apparatus, and non-transitory computer-readable medium described above may further include processes, features, means, or instructions for identifying a condition of the signal strength of the serving cell that indicates a low signal to noise plus interface ratio (SINR), a fluctuating signal, or a fast fading signal, or any combination thereof. Some examples of the method, apparatus, and non-transitory computer-readable medium described above may further include processes, features, means, or instructions for modifying the second threshold based at least in part on identifying the condition.

In some examples of the method, apparatus, and non-transitory computer-readable medium described above, determining that the identifier may be on the list further comprises: receiving an indication from the base station that the serving cell may be on the list.

Some examples of the method, apparatus, and non-transitory computer-readable medium described above may further include processes, features, means, or instructions for determining that an RLF event occurred while communicating over the serving cell, wherein the measurement report includes a reference signal received power (RSRP) of the serving cell when the RLF event occurred or a location of the UE when the RLF event occurred, or both, and updating the list of cells based at least in part on determining that the RLF event occurred.

### BRIEF DESCRIPTION OF THE DRAWINGS

FIG. 1 illustrates an example of a system for wireless communication that supports inter-RAT mobility measurements and operations to support UE connectivity in accordance with aspects of the present disclosure.

FIG. 2 illustrates an example of a multi-RAT wireless communication system that supports inter-RAT mobility measurements and operations to support UE connectivity in accordance with aspects of the present disclosure.

FIG. 3 illustrates an example of a plot over time of signals measured at the UE that supports inter-RAT mobility measurements and operations to support UE connectivity in accordance with aspects of the present disclosure.

FIG. 4 illustrates an example of a method implemented by a UE that supports inter-RAT mobility measurements and operations to support UE connectivity in accordance with aspects of the present disclosure.

FIG. 5 illustrates an example of a list that supports inter-RAT mobility measurements and operations to support UE connectivity in accordance with aspects of the present disclosure.

FIGS. 6 through 8 show block diagrams of a device or devices that support inter-RAT mobility measurements and operations to support UE connectivity in accordance with aspects of the present disclosure.

FIG. 9 illustrates a block diagram of a system including a UE that supports inter-RAT mobility measurements and operations to support UE connectivity in accordance with aspects of the present disclosure.

FIGS. 10 through 11 illustrate methods for inter-rat mobility measurements and operations to support UE connectivity in accordance with aspects of the present disclosure.

### DETAILED DESCRIPTION

Currently communication networks using LTE and communication networks using 3G technology may be deployed simultaneously. Many UEs may use either LTE radio access network or a 3G RAT to connect to a network, such as the internet. In some areas, LTE connectivity is reliable because the LTE network has been properly planned and built up by the network operator. In other areas, however, LTE connectivity may not be as reliable as 3G connectivity. This may be due to the LTE network being inefficiently planned or being immature (e.g., not completely built up). In areas where the LTE connectivity is not as reliable, the UE may experience an RLF event because of abrupt coverage holes in the LTE communication network.

In addition, the LTE communication standard was designed as an improved alternative to the 3G communication standard. As such, UEs operating according to the LTE standard may operate with a preference for being and remaining connected via the LTE communication network. For example, signal strength and quality thresholds that affect mobility between LTE and a 3G system may be set to increase the likelihood that a UE will remain on an LTE network. For example, before a UE transitions from using an LTE network to using a 3G network, the UE may determine whether a so-called B2 measurement event has occurred. The B2 measurement event indicates that the LTE signal is worse than a defined first threshold and the 3G signal is better than a defined second threshold. The selection of these thresholds may affect when inter-RAT handover events occur. In some examples, a UE may experience an RLF event before being able to handover to a legacy RAT (e.g., 3G) based at least in part on the LTE handover standards and an immature LTE physical network.

To avoid RLF events in areas known to have less reliable LTE coverage, techniques are disclosed herein to modify UE operations, such as a determination regarding B2 event thresholds. The UE may determine whether the LTE serving cell or the LTE coverage area is on a list of offenders. The list of offenders may indicate LTE cells or LTE coverage areas that experience RLF events even though reliable 3G coverage exists. If the serving cell or the coverage area is on the list of offenders, the UE may modify one or more of the B2 thresholds to cause an early trigger of an inter-RAT handover event. In this manner, the UE may maintain connectivity by switching to a 3G network from an LTE network prior to experiencing an RLF event in a coverage area with known LTE coverage holes. The early triggering of such handover related events may help a UE to avoid experiencing RLF, help to provide reliable connectivity, help to drop less call, or various combinations thereof.

Aspects of the disclosure introduced above are described below in the context of a wireless communication system. Aspects of the disclosure are further illustrated by and described with reference to apparatus diagrams, system diagrams, and flowcharts that relate to inter-RAT mobility measurements and operations to support UE connectivity.

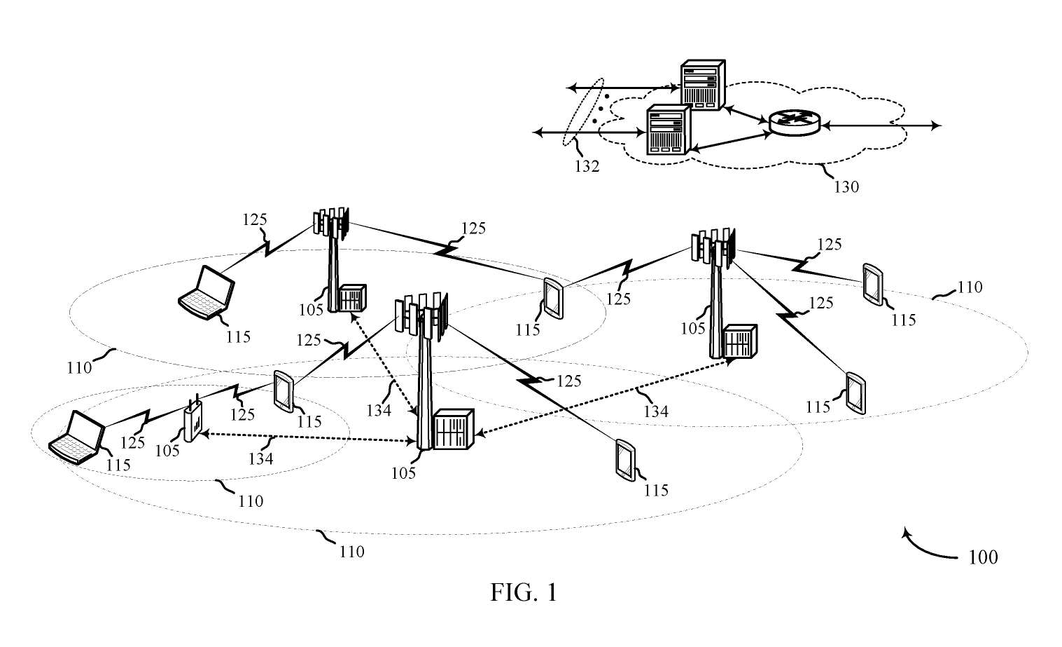

FIG. 1 illustrates an example of a wireless communication system 100 in accordance with various aspects of the present disclosure. The wireless communication system 100 includes base stations 105, UEs 115, and a core network 130. In some examples, the wireless communication system 100 may be a LTE (or LTE-Advanced) network. To address known coverage holes of a first wireless communication network using a first RAT (e.g., LTE), techniques are disclosed herein to track and communicate known coverage holes to UEs and initiate inter-RAT handovers at an earlier time, if the coverage holes are better served by a second wireless network using a second RAT (e.g., UMTS, CDMA2000, GSM, or the like).

Base stations 105 may wirelessly communicate with UEs 115 via one or more base station antennas. Each base station 105 may provide communication coverage for a respective geographic coverage area 110. Communication links 125 shown in wireless communication system 100 may include UL transmissions from a UE 115 to a base station 105, or DL transmissions, from a base station 105 to a UE 115. UEs 115 may be dispersed throughout the wireless communication system 100, and each UE 115 may be stationary or mobile.

A UE 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of things (IoT) device, an Internet of Everything (IoE) device, a machine type communication (MTC) device, an appliance, an automobile, or the like.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

A UE 115 may measure signal strength for various cells within a network. An LTE measurement, referred to as Reference Signal Received Power (RSRP), provides a cell-specific signal strength metric. This measurement may be used to rank different LTE cells according to their signal strength as an input for handover and cell reselection decisions. The RSRP of a cell may be defined as the linear average over the power contributions (in Watts) of the Resource Elements (REs) which carry cell-specific RS within the considered measurement bandwidth. RSs transmitted on the first eNodeB antenna port are used for RSRP determination, but the RS on the second antenna port can also be used if the UE can determine that they are being transmitted. If the UE is equipped with multiple antennas, the reported RSRP value may not be permitted to be lower than the RSRP computed on the individual branches.

In addition, Reference Signal Received Quality (RSRQ) may be an LTE measurement, which provides a cell-specific signal quality metric. Similarly to Reference RSRP, this measurement may be used to rank different LTE cells according to their signal quality as an input for handover and cell reselection decisions, for example in scenarios for which RSRP measurements do not provide sufficient information to perform reliable mobility decisions. The RSRQ may be defined as the ratio N×RSRP/(LTE carrier RSSI), where N is the number of Resource Blocks (RBs) of the LTE carrier Received Signal Strength Indicator (RSSI) measurement bandwidth.

While RSRP may be an indicator of the wanted signal strength, RSRQ may additionally take the interference level into account due to the inclusion of RSSI. RSRQ may therefore enable the combined effect of signal strength and interference to be reported in an efficient way. If the UE is equipped with multiple antennas, the reported RSRQ value may not be permitted to be lower than the RSRQ computed on the individual branches.

A base station 105 may provide a UE 115 with a measurement reporting configuration as part of a radio resource control (RRC) configuration. The measurement reporting configuration may include parameters related to which neighbor cells and frequencies the UE 115 should measure, criteria for sending measurement reports, intervals for transmission of measurement reports (i.e., measurement gaps), and other related information. In some cases, measurement reports may be triggered by events related to the channel conditions of the serving cells or the neighbor cells.

For example, in an LTE system a first report (A1) may be triggered when the serving cell becomes better than a threshold; a second report (A2) when the serving cell becomes worse than a threshold; a third report (A3) when a neighbor cell becomes better than the primary serving cell by an offset value; a fourth report (A4) when a neighbor cell becomes better than a threshold; a fifth report (A5) when the primary serving cell becomes worse than a threshold and a neighbor cell is simultaneously better than another (e.g., higher) threshold; a sixth report (A6) when a neighbor cell becomes better than a secondary serving cell by an offset value; a seventh report (B1) when a neighbor using a different RAT becomes better than a threshold; and an eighth report (B2) when a primary serving cell becomes worse than a threshold and the inter-RAT neighbor becomes better than another threshold.

In some cases, the UE 115 may wait for a timer interval known as time-to-trigger (TTT) to verify that the trigger condition persists before sending the report. Other reports may be sent periodically instead of being based on a trigger condition (e.g., every two seconds a UE 115 may transmit an indication of a transport block error rate).

Transmitting a measurement report may trigger a handover according to the reported event. So as described herein, a UE 115 may modify one or more thresholds associated with a handover event (or mobility procedure trigger) in order to avoid operation that may not account for network-specific conditions. For example, the UE 115 may modify a threshold to decrease its tendency to stay on an LTE network if the LTE network is determined to have reliability issues, such as coverage holes or frequent RLF events.

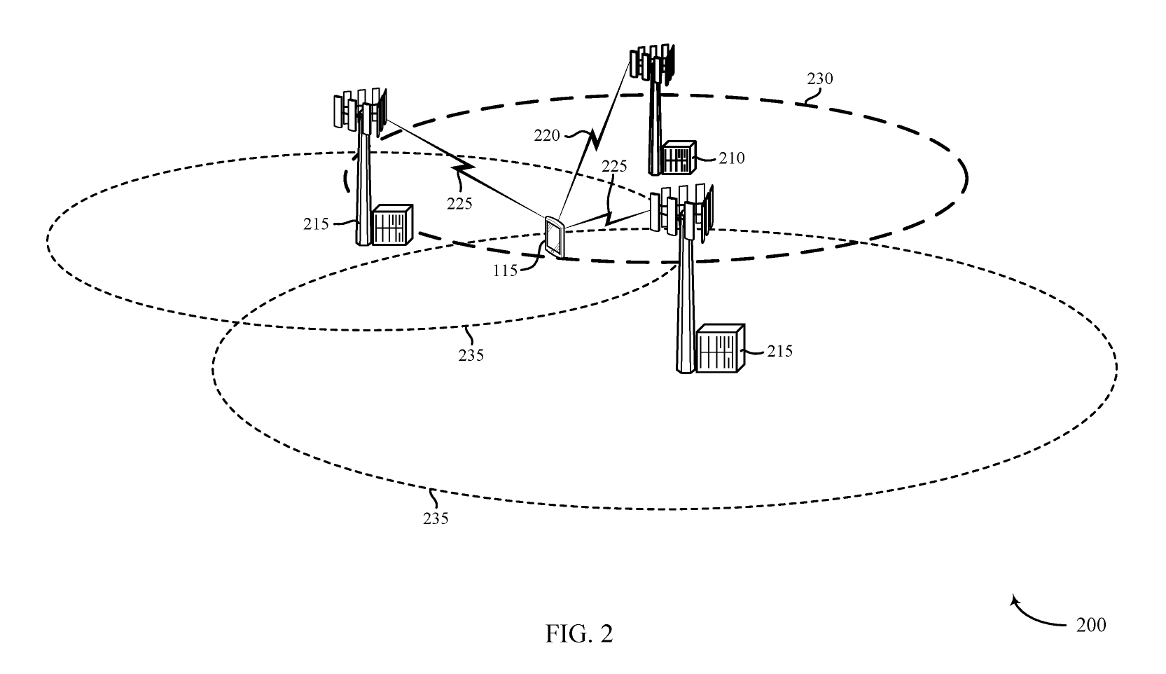

FIG. 2 illustrates an example of a multi-RAT wireless communication system 200 for inter-rat mobility measurements and operations to support UE connectivity. The multi-RAT wireless communication system 200 may include a UE 115, a serving cell 210, and one or more neighboring cells 215. The UE 115 may be an example of the UE 115 described in relation to FIG. 1. The serving cell 210 and the neighboring cells 215 may be examples of the base stations 105 described in relation to FIG. 1.

The serving cell 210 may communicate with the UE 115 via a wireless communication link 220 using a first RAT. For example, the serving cell 210 may communicate with the UE 115 using an LTE communication link. The serving cell 210 may also have a coverage area 230 associated with the first RAT. The coverage area 230 may define the geographic limits that a UE 115 may communicate with the serving cell 210 successfully using the first RAT.

The neighboring cells 215 may communicate with the UE 115 via wireless communication links 225 using a second RAT. The second RAT being different from the first RAT. For example, in some cases, the first RAT may be LTE and the second RAT may be a 2G or 3G RAT. The neighboring cells 215 may also define coverage areas 235 associated with the second RAT. The coverage area 235 may define the geographic limits that a UE 115 may communicate with the neighboring cells 215 successfully using the second RAT.

The UE 115 may be configured to communicate using either the first RAT or the second RAT. For example, a UE 115 may be capable of communicating using an LTE network or a 3G network, depending on network conditions. In some examples, the UE 115 may prefer to use the first RAT over the second RAT based on characteristics of the UE 115 or the characteristics of the RATs in question. As discussed above, the LTE standard defines protocols and procedures that may cause a UE 115 to prefer to communicate via LTE over 3G. However, in other situations, other preferences may exist. For example, a UE 115 may prefer to communicate via a Wi-Fi network over a LTE network or a 3G network when the Wi-Fi network is available.

Wireless communication networks using various RATs are designed to have coverage areas that overlap. In this manner, a UE 115 may be able to maintain communication links with the wireless communication network, even when the UE 115 is moving between coverage areas of different cells. In some cases, wireless communication networks may have abrupt coverage holes, or locations where a UE 115 suddenly loses its communication link to the wireless network. A sudden loss of a communication link may be referred to as a radio link failure (RLF) event. Coverage holes may be caused by an immature network (e.g., the wireless network is not completely built up), an inefficiently planned network, equipment inefficiencies or failure, other factors, or any combination thereof.

To avoid RLF events, a UE 115 may measure relative signal strengths and quality of different communication links using different RATs. If certain conditions are met, a handover event may be initiated. The handover event may transition the UE 115 to a neighboring cell 215 (from the serving cell 210), such that the UE 115 establishing a communication link with the neighboring cell using the first RAT. In other examples, the handover event may be an inter-RAT handover event where the UE 115 establishes a communication link 225 with the neighboring cell 215 using a second RAT different from the first RAT.

However, in some instances, the characteristics of the coverage hole may prevent a handover event from being triggered in time. The conditions to initiate a handover event may not be met with enough time to execute a handover procedure prior to an RLF event occurring. Such conditions may include, the signal power of the serving cell 210 fluctuating frequently, causing a ping-pong and never satisfying the predetermined timers associated with the thresholds), the signal power of the serving cell 210 fading quickly, leaving insufficient time to execute fully handover commands, or a combination thereof. Instances of RLF may be more prominent when the UE 115 is using Voice over LTE (VoLTE) to make a telephone call. When using VoLTE, RLF events may result in the telephone call being dropped. In addition, VoLTE uses different principles of operation to communicate voice data than 3G, and a handover event between LTE and 3G may take additional time.

In some instances, the location of coverage holes may be known. For example, in FIG. 2, the UE 115 is positioned at the edge of a coverage area 230 of the first RAT, but the UE 115 is positioned well-within multiple coverage areas 235 of the second RAT. Techniques are disclosed herein to modify the conditions for initiating an inter-RAT handover event when the UE 115 is located in a known problematic area or coverage hole of the first RAT, but the second RAT has sufficient coverage and connectivity.

In some examples, the serving cell 210 may also be able to communicate with the UE 115 via the second RAT (e.g., 3G). As such, the serving cell 210 and the UE 115 may establish a communication link using the second RAT. The serving cell 210 may also define a coverage area 235 associated with the second RAT.

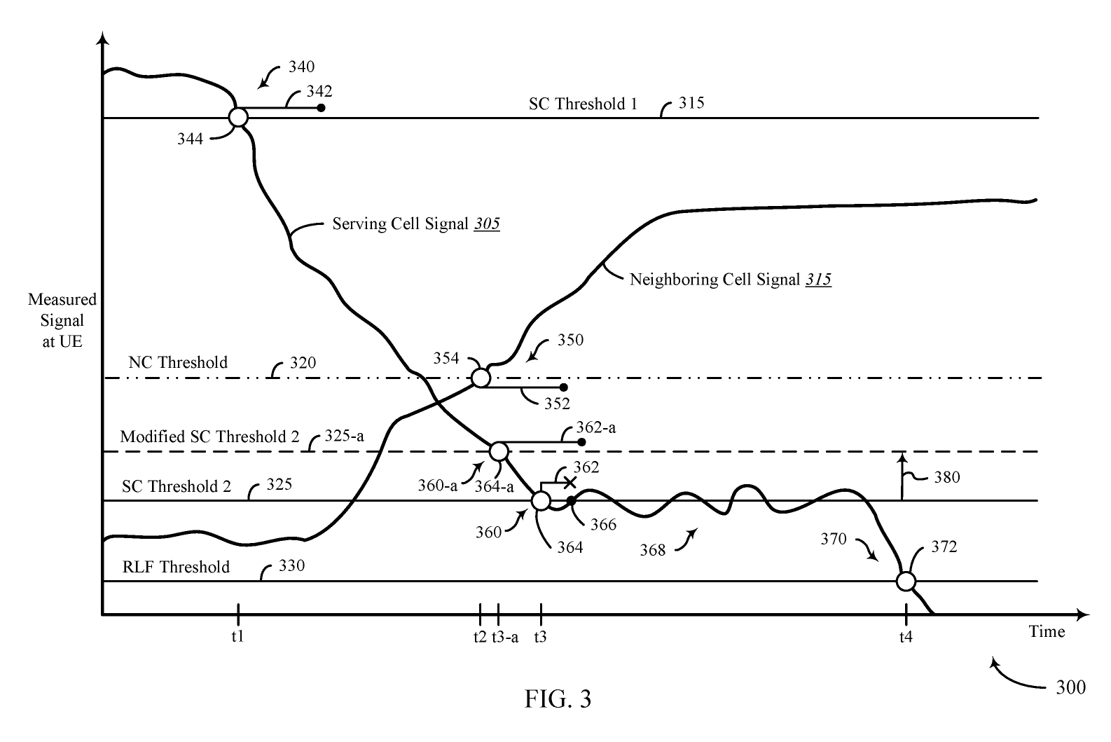

FIG. 3 illustrates an example of a plot 300 over time of signals measured at a UE that supports inter-RAT mobility measurements and operations in accordance with the present disclosure. The plot 300 indicates signal strengths measured by a UE 115 plotted over time, and indicates various thresholds and events that should be satisfied before an inter-RAT handover event is initiated.

Before an inter-RAT handover event occurs, a number of conditions at the UE 115 may be met. These conditions may be different depending on the which RATs are involved in the inter-RAT handover event. For example, when a UE is handed over from an LTE network to a 3G network, an A2 measurement event may be satisfied and a B2 measurement event may be satisfied. Each of these events defines a different set of conditions, as discussed above. For instance, in LTE, the A2 measurement event may occur when the signal strength of the serving cell 210 becomes worse than a threshold. In LTE, the B2 event may occur when the signal strength of the serving cell 210 (using a first RAT, e.g., LTE) becomes worse than a first threshold and the signal strength of neighboring cell 215 (using a different RAT, e.g., 3G) becomes better than a second threshold different than the first threshold.

The plot 300 includes a serving cell signal 305 and a neighboring cell signal 310. The serving cell signal 305 indicates the signal strength of the signal received from the serving cell 210 as measured by the UE 115. In the illustrative example, the serving cell signal 305 is communicated using a first RAT (e.g., LTE). The neighboring cell signal 310 indicates the signal strength of the signal received from a neighboring cell as measured by the UE 115. In the illustrative example, the neighboring cell signal 310 may be communicated using a second RAT (e.g., 3G) different than the first RAT.

The plot 300 also includes a first serving cell (SC) threshold 315, a neighboring cell (NC) threshold 320, a second SC threshold 325, a RLF threshold 330, and a modified second SC threshold 325-a. These thresholds are associated with thresholds relevant to initiating an inter-RAT handover event. Each of the thresholds 315, 320, 325, 330, 335 may also include hysteresis margins. However, such hysteresis margins are not explicitly shown in FIG. 3.

At t1, a first handover event 340 at the UE 115 may occur. In some examples, the first handover event 340 may be an A2 measurement event as defined in the LTE standard. The first handover event 340 includes the serving cell signal 305 satisfying the first SC threshold 315. For the first handover event 340 to be triggered or to occur, the serving cell signal 305 should become worse than the first SC threshold 315 for a first predetermined time 342. The serving cell signal 305 may drop below the first SC threshold 315 at a crossing 344 and remain worse than the first SC threshold 315 for the first predetermined time 342. The first predetermined time 342 may be based on any number of factors. The length of the first predetermined time 342 is shown in FIG. 3 for illustrative purposes only, and is not meant to be limiting. Hysteresis margins and/or predetermined times may be used as conditions to trigger the first handover event 340 in an effort to prevent false positive triggers. For example, the serving cell signal 305 may briefly become worse than the first SC threshold 315 but may immediately bounce back above the first SC threshold 315. In such an instance, the first predetermined time 342 or the hysteresis margin may not be satisfied and the first handover event 340 may be deemed not to have occurred.

Once the first handover event 340 occurs or is triggered, the UE 115 may begin taking other measurements to determine the signal strengths of other cells surrounding the UE 115. For example, the UE 115 may begin measuring the signals of other cells nearby that use the first RAT and other cells nearby that use the second RAT. If certain conditions are met, the UE 115 may be handed-over to one of the neighboring cells 215.

At t2, a second handover event 350 at the UE 115 may occur. In some examples, the second handover event 350 may be a portion of a B2 measurement event as defined in the LTE standard. The second handover event 350 may include the neighboring cell signal 310 satisfying the NC threshold 320. For the second handover event 350 to be triggered or to occur, the neighboring cell signal 310 may become better than the NC threshold 320 for a second predetermined time 352. The neighboring cell signal 310 may rise above the NC threshold 320 at a crossing 354 and remain better than the NC threshold 320 for the second predetermined time 352. In some examples, the second predetermined time 352 is the same as the first predetermined time 342. In some examples, the second predetermined time 352 is different from the first predetermined time 342.

By way of example, for an inter-RAT handover to occur, trigger conditions related to the first handover event 340, the second handover event 350, and a third handover event 360 may be satisfied. At t3, the third handover event 360 at the UE 115 may not occur. In some examples, the third handover event 360 may be a portion of a B2 measurement event as defined in the LTE standard. The third handover event 360 may include the serving cell signal 305 satisfying the second SC threshold 325. For the third handover event 360 to occur, the serving cell signal 305 may, for example, become worse than the second SC threshold 325 for a third predetermined time 362.

The serving cell signal 305 may fall below the second SC threshold 325 at a crossing 364 but the serving cell signal 305 does not remain worse than the second SC threshold 325 for the third predetermined time 362. Instead, the serving cell signal 305 becomes better than the second SC threshold 325 at crossing 366 prior to the third predetermined time 362 expiring. In this manner, FIG. 3 illustrates a situation where the conditions precedent of the third handover event 360 are not satisfied and, therefore, the third handover event 360 does not occur.

In other examples, the conditions precedent of the third handover event 360 may occur. The failure of the third handover event 360 to occur is illustrated, in part, to demonstrate the conditions that may be solved by the techniques described herein. In some examples, the third predetermined time 362 is similar to the second predetermined time 352 and the first predetermined time 342. In some examples, the third predetermined time 362 is different from the second predetermined time 352 or the first predetermined time 342.

At area 368, as depicted in FIG. 3, the signal strength of the serving cell signal 305 may be fluctuating and/or fading quickly. The fluctuations may cause the serving cell signal 305 to frequently cross the second SC threshold 325, but the serving cell signal may not satisfy the third predetermined time 362. In some instances, the UE 115 may be moving through the coverage area 230 of the serving cell 210 such that it is located in a coverage hole or the UE 115 has left the coverage area 230. In these instances, a rapid decline in the signal strength may precipitate an RLF event 370.

The RLF threshold 330 may be the threshold below which a UE 115 cannot continue to communicate with a cell via a particular RAT. The RLF threshold 330 may vary depending on a number of conditions, such as the UE 115, the type of RAT being employed, the base station being used, environment conditions, distance between the UE 115 and the serving cell 210 or various other factors. In some examples, the RLF threshold 330 is not a predetermined threshold, but is a physical threshold below which a communication link cannot be maintained. At t4, the serving cell signal 305 becomes worse than the RLF threshold at crossing 372. At such a time, the communication link 220 between the UE 115 and the serving cell 210 may be terminated. Because of the area 368 of fluctuating signal and the rapid decline in the serving cell signal 305, no handover event, whether inter-RAT or intra-RAT, was fully executed.

To prevent RLF events (e.g., RLF event 370) from occurring, at least one of the thresholds associated with a handover event may be modified. For instance, the second SC threshold 325 may be modified to form a modified second SC threshold 325-a. As is discussed herein, the modified second SC threshold 325-a may be generated based at least in part on information included in an offenders list. The offenders list may comprise serving cells or locations that may experience abrupt RLF events before a handover may be fully executed. In some examples, the modified second SC threshold 325-a is generated by applying an offset 380 to the second SC threshold 325. As shown in FIG. 3, at t3-a, the modified third handover event 360-a may occur because the serving cell signal 305 becomes worse than the modified second SC threshold 325-a (e.g., at crossing 364-a) for the third predetermined time 362-a. Because handover events 340, 350, and 360-a may be satisfied in the illustrative example, an inter-RAT handover event may be initiated. In some examples, the handover events 340, 350, and 360-a may occur within a certain time period of each other for an inter-RAT handover event to be initiated. Exemplary techniques for modifying the second SC threshold 325 are discussed in more detail below.

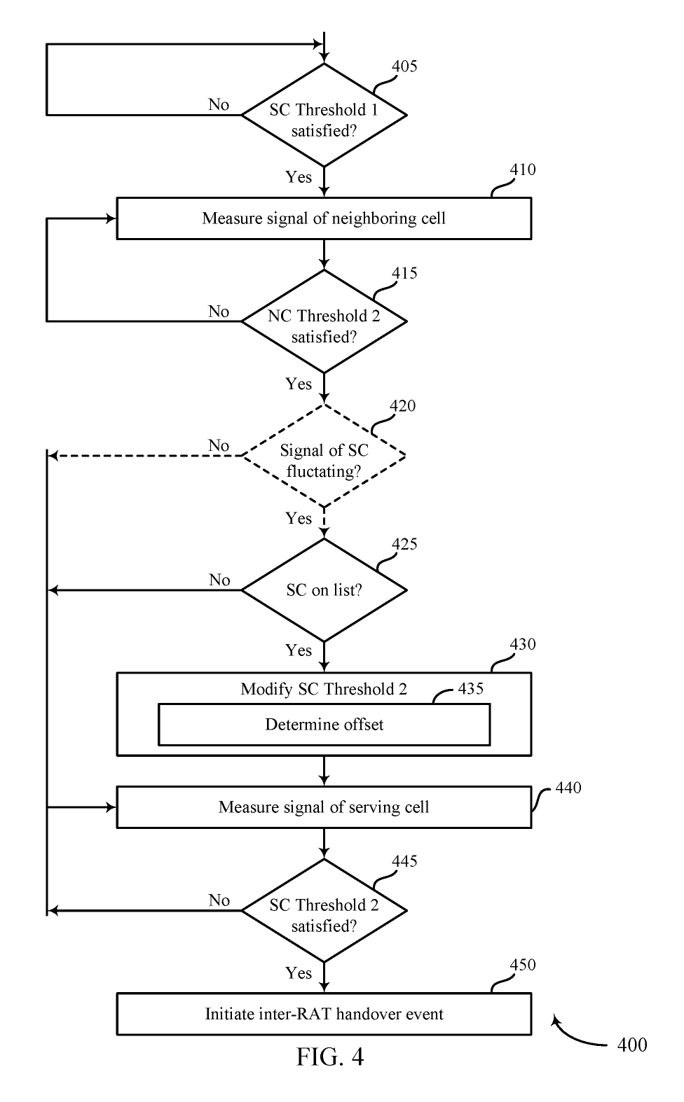

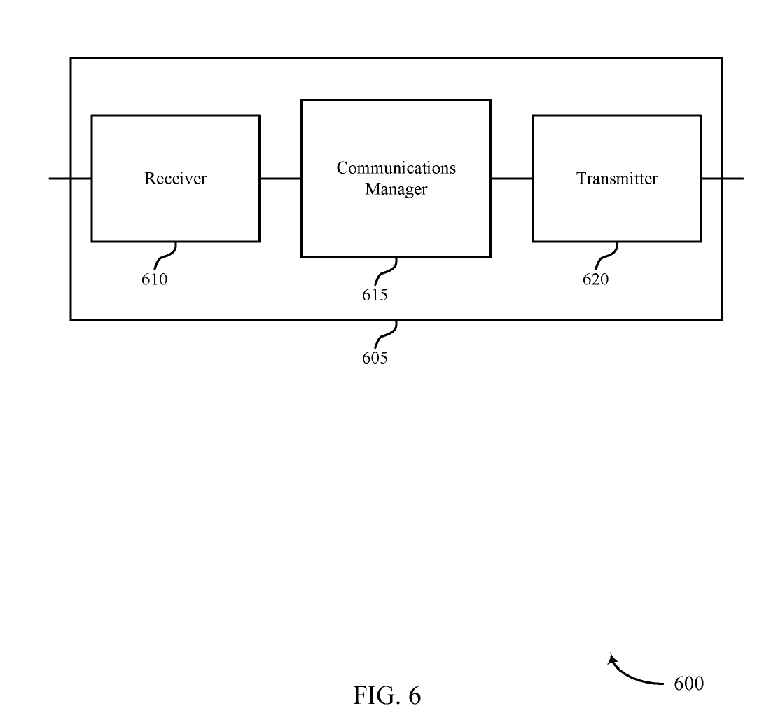

FIG. 4 illustrates an example of a method 400 implemented by a UE for inter-RAT mobility measurements and operations to support UE connectivity. The operations of the method 400 may be implemented by a UE 115 or its components as described herein. For example, the operations of method 400 may be performed by a communications manager as described with reference to FIGS. 6 through 9. In some examples, a UE 115 may execute a set of codes to control the functional elements of the device to perform the functions described below. Additionally or alternatively, the UE 115 may perform aspects the functions described below using special-purpose hardware.

At block 405, the UE 115 may determine whether a signal strength of the serving cell signal 305 has satisfied the first SC threshold 315 such that the first handover event 340 occurs. As part of this determination, the UE 115 may receive a plurality of signals from the serving cell 210, including reference signals. The UE 115 may measure the received signals and compare the measurements to the first SC threshold 315. If the first SC threshold 315 is not satisfied (i.e., the serving cell signal 305 is better than the first SC threshold 315), the UE 115 may continue to measure the serving cell signal 305 and compare it to the first SC threshold 315.

If the first SC threshold 315 is satisfied and the first handover event 340 occurs, the UE 115 may attempt to determine if a handover event should be initiated. The handover event could be an intra-RAT handover event or an inter-RAT handover event. At block 410, the UE 115 may measure the signal strength of signals received from neighboring cells 215. To do this, the UE 115 may receive a plurality of signals from the neighboring cells 215, including reference signals. For example, the UE 115 may determine the neighboring cell signal 310. The signals from neighboring cells 215 may include signals using the same RAT as the serving cell signal 305, or may include signals using a different RAT from the serving cell signal 305. In some examples, a neighboring cell signal 310 may include a signal received from the serving cell 210, but the neighboring cell signal 310 is using a different RAT from the serving cell signal 305.

At block 415, the UE 115 may determine whether the neighboring cell signal 310 satisfies the NC threshold 320. As discussed above, the NC threshold 320 may be associated with a second handover event 350. The second handover event 350 may be one of the conditions precedent to an inter-RAT handover event being initiated. If the NC threshold 320 is not satisfied, the method 400 may return to block 410 and continue to measure the neighboring cell signal 310. If the NC threshold 320 is satisfied, the method 400 may execute other blocks. Blocks 410, 415 may be independently executed from some of the other blocks of the method 400. As such, blocks 410, 415 may be performed at any time prior to an inter-RAT handover event being initiated (e.g., at block 450). In some examples, blocks 410, 415 may be performed in parallel with the other blocks of the method 400.

At block 420, the UE 115 may determine whether the signal from the serving cell 210 (e.g., serving cell signal 305) is fluctuating or otherwise exhibiting erratic readings. In some examples, the fluctuating may be with reference to a particular measurement threshold. For example, a signal within area 368 shows fluctuation around the second SC threshold 325. Such fluctuations may prevent a handover event from occurring because the signal does not satisfy the second SC threshold for the third predetermined time 362. Examples of fluctuating signals may include a fluctuating signal-to-interference-plus noise (SINR) ratio, a fluctuating RSRP, a fast fading RSRP, other signal indicators, or various combinations thereof. SINR may refer to the ratio of the average received modulated carrier power to the sum of the average co-channel interference power (i.e. signals other than the wanted signal) and the noise power from other sources (typically thermal noise, modelled as Additive White Gaussian Noise (AWGN)), which are simultaneously received.

Fluctuating signals may be indicative that a UE 115 connected to the serving cell 210 may experience an RLF event 370 at a later time. If fluctuating signals are detected, the method 400 may move to block 425. If fluctuating signals are not detected, the method 400 may not modify the second SC threshold 325. Block 425 may be performed independently of other blocks. As such, block 425 may be performed in parallel to other blocks of the method 400. In some examples, the UE 115 may perform the functions of block 420 after performing the functions of block 425. Meaning the UE 115 may look for fluctuating signals after determining that a serving cell or a location is on a list 500 of offenders.

At block 425, the UE 115 may determine whether the serving cell 210 or the location of the UE 115 is on a list of that indicates at least one prior measurement procedure has failed and a radio link failure (RLF) condition resulted.

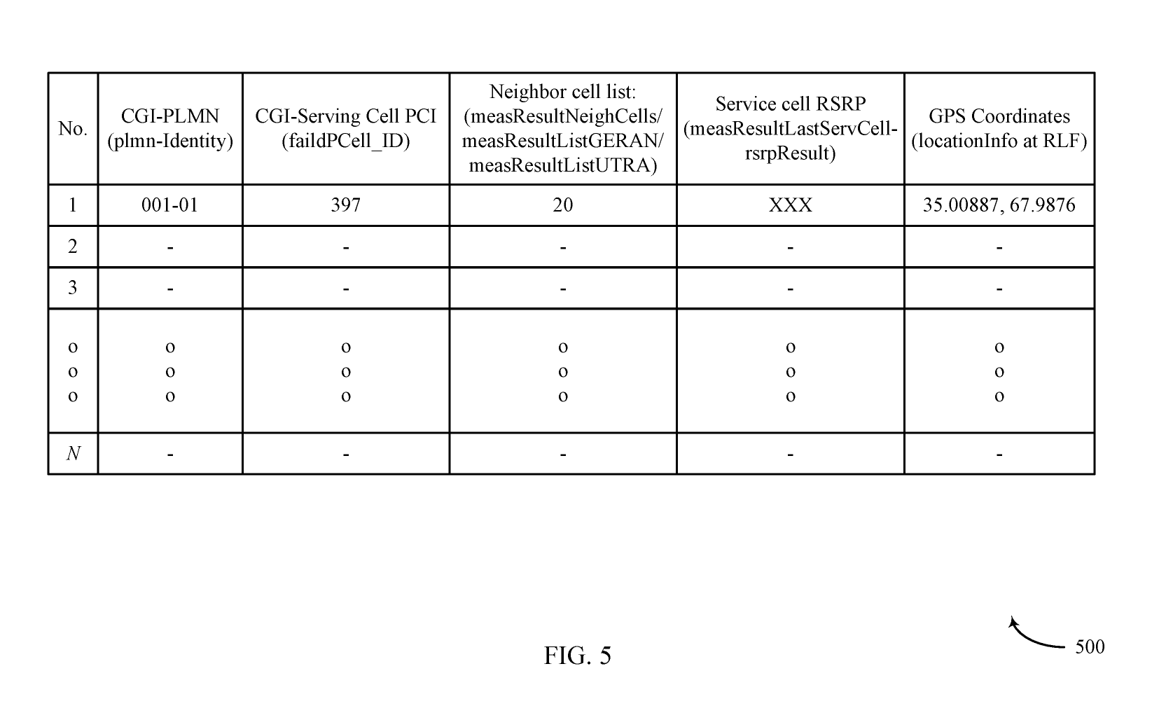

FIG. 5 illustrates an example of such a list 500 used to support inter-RAT mobility measurements and operations to support UE connectivity. The list 500 may be an example of an offenders list for a first RAT. The list 500 may include collection of serving cells in a communication network where the UE 115 experienced an RLF event without having enough time to execute or initiate an inter-RAT handover event. In some examples, the list 500 may include a collection of locations or geographic areas in a communication network where the UE 115 experienced an RLF event without having enough time to execute or initiate an inter-RAT handover event.

In some instances, the list 500 may be stored locally on the UE 115. In such instances, the UE 115 may periodically request that its serving cell 210 update the list 500. In other instances, the list 500 may be stored on the communication network. In such instances, the serving cell 210 may send an indication to the UE 115 that it is on the offenders list 500. Such an indication may be transmitted upon establishing a communication link 220 with the UE 115, upon a first handover event 340 occurring, or at some other time. In some examples, the indication may be as simple as single bit indicating whether the serving cell 210 is on the offenders list 500. In some examples, the indication may indicate that a location in the coverage area 230 of the serving cell 210 is on the list 500.

In some examples, the UE 115 may build an individual list 500 based at least in part on RLF events experienced by the UE 115. For example, if a UE 115 hits RLF while communicating over a particular cell, the UE 115 may add that particular cell. The UE 115 may then use its unique list 500 to determine whether to modify certain thresholds as part of an inter-RAT handover measurements. In some approaches, the individual list 500 maintained by the UE 115 may include geographic locations of the UE 115 when an RLF event occurs. In some examples, the UE 115 may share its individual list 500 with other UEs 115, base stations 105, the network, or any combination thereof.

To generate the offenders list 500, the wireless communication system 200 may aggregate certain RLF reports received by the network. When a UE 115 experiences an RLF event, after re-establishing a communication link with the wireless communication system 200, the UE 115 may send an RLF report. The RLF may include certain types of information, such as an identification of the serving cell at the time of RLF, the signal quality/strength of the serving cell signal at the time of RLF (e.g., a received signal strength RSSI, a RSRP, RSRQ), signal quality/strength measurements of neighboring cells at the time of RLF, or various combinations thereof. In some examples, the RLF report may include geographic locations of where the RLF event occurred.

The offenders list 500 may be generated or populated by aggregating RLF reports where the UE 115 was able to find cells using a first RAT (e.g., LTE). If the UE 115 could not communicate with the first RAT, the RLF could not be caused by coverage holes in the communication network using the first RAT. By way of example, RLF reports with no EUTRAN list in a measResultNeighCells information element may be aggregated into the list 500. When no cells are reported on the EUTRAN list, this may indicate that when the UE 115 experienced RLF, the UE 115 could not find any cells that use the first RAT (e.g., LTE). If the UE 115 could find cells that used the first RAT, triggering an inter-RAT handover event early may be useful to avoid RLF events in the future.

In some examples, the UE 115 may include location component configured to determine the location of the UE 115. For example, the location component may be a global-positioning (GPS) device. In some instances, upon experiencing an RLF event 370, a UE 115 may log its current location. After logging its current location, the UE 115 may report that location to the wireless communication system 200 as part of the RLF report. In this manner, a map of coverage holes may be generated based on the locations of RLF events in a communication network that uses the first RAT. In some examples, the list 500 may occasionally be audited and certain entries removed.

In the example illustrated in FIG. 4, if the serving cell 210 or the location of the UE 115 is on the offenders list 500, the method 400 may move to block 430 to modify the second SC threshold 325. If the serving cell 210 or the location of the UE 115 is not on the offenders list 500, the method 400 may skip any modifications of the second SC threshold 325 and measure the signal strength of the serving cell 210 at block 440.

At block 430, the UE 115 may modify the second SC threshold 325 to generate a modified second SC threshold 325-a. At block 435, the UE 115 may determine an offset 380 as part of modifying the second SC threshold. The modification may be based at least in part on an offset 380 determined by the UE 115. In some examples, the offset 480 may be a predetermined offset for cells or locations on the list 500. In some examples, the offset 380 may be tailored based on the information on the list 500. For instance, the offset 380 may be determined based at least in part on information associated with the serving cell 210 or the locations included in list 500. In some examples, the offset 380 may be determined based at least in part on the last measured signal strength of the serving cell 210. In some examples, the offset 380 may be determined based at least in part on machine-learning techniques such as altering the offset 380 for a particular cell on the list 500 until the number of RLF events associated with the particular cell satisfies a threshold.

In some examples, the UE 115 may also modify the NC threshold 320 in a similar manner as described above. For instance, the NC threshold 320 may be modified such that it is less than the current NC threshold 320. In some examples, the NC threshold 320 may be modified instead of the second SC threshold 325.

At block 440, the UE 115 may measure the signal strength of the signal received from the serving cell 210. At block 445, the UE 115 may determine whether the measured signal strength satisfies the second SC threshold 325 or the modified second SC threshold 325-a such that the third handover event 360 occurs. If the third handover event 360 does not occur, the method 400 may return to block 440 and continue measuring the signal of the serving cell 210. However, if the first handover event 340, the second handover event 350, and the third handover even 360 are satisfied, the UE 115 may initiate an inter-RAT handover event.

At block 450, the UE may initiate an inter-RAT handover event. In some instances, the UE 115 may transmit a measurement report to the serving cell 210. The measurement report may include indications about the various measurement events that may be implemented by the UE 115 (e.g., an A2 event or a B2 event). In some examples, the measurement report may include information related to modified thresholds (e.g., the modified second SC threshold 325-a), offsets used to modify the thresholds (e.g., the offset 380), information regarding whether an modification may have been employed or beneficial, or other information, or any combination thereof. In other examples, the measurement report may include only indications whether thresholds have been satisfied and events have occurred. For example, the measurement report may indicate merely that a third handover event 360 has occurred. In these examples, the measurement report may not indicate whether a modified threshold is used or not.

Upon receiving the measurement report, the serving cell 210 may determine whether the conditions for an inter-RAT handover event have been satisfied. For example, if the measurement report indicates that the first handover event 340, the second handover event 350, and the third handover event 360 have occurred, the serving cell 210 may transmit to the UE 115 an inter-RAT handover command. After such a command has been transmitted, the serving cell 210, the neighboring cell 215, and the UE 115 may cooperate to execute the procedures to perform an inter-RAT handover of the UE 115.

In some examples, the UE 115 may unilaterally initiate an inter-RAT handover event. In such examples, the UE 115 may initiate a connect to legacy RAT procedure while still connected via a first RAT and without permission of the serving cell 210. In some situations, the risk of a sudden RLF event occurring is high enough that such a procedure may be helpful to maintain connectivity of the UE 115 to a network.

In some examples, the UE 115 may use lean measurement information included in a measurement report to perform the functions described herein. The number of measurements reports generated and transmitted may be based on a parameter (e.g., reportAmountr1). The more measurement reports indicated by the parameter, the more time it may take for the network to respond and/or execute a given action (e.g., executing an inter-RAT handover). In some cases, another value may be included in the measurement report. Such a value, when set to true, may cause the network to ignore the parameter and respond after a single B2 measurement is performed. The value may be set to true when one of the neighboring cells 215 is present in a neighbor cell list column in the list 500. Such an approach may decrease turnaround time between handover events occurring and an inter-RAT handover event occurring. In addition, the probability of false triggers may be reduced with a check of the list 500.

In some examples, the list 500 may also include location information to better handle the handover events that may occur. In such examples, a GPS coordinates column of the list 500 may be used to ensure early modification to one of the thresholds. To accomplish this, the UE 115 may determine its GPS coordinates when an RLF occurs. Instances where one of the thresholds is satisfied (e.g., NC threshold 320) but not the other threshold (e.g., second SC threshold 325) may use a modem location to decide if the UE 115 is approaching a vicinity of a coverage hole. In such situations, a modified second SC threshold 325-a may be generated to trigger early B2 measurements. Such examples may increase the precision of the threshold modifications described herein and thereby increase the amount of time UE 115 may be connected via the first RAT (e.g. LTE). In such situations, VoLTE call performance may see an improvement.

FIG. 6 shows a block diagram 600 of a wireless device 605 that supports inter-rat mobility measurements and operations to support UE connectivity in accordance with various aspects of the present disclosure. Wireless device 605 may be an example of aspects of the UE 115 as described with reference to FIG. 1. Wireless device 605 may include receiver 610, communications manager 615, and transmitter 620. Wireless device 605 may also include a processor. Each of these components may be in communication with one another (e.g., via one or more buses).

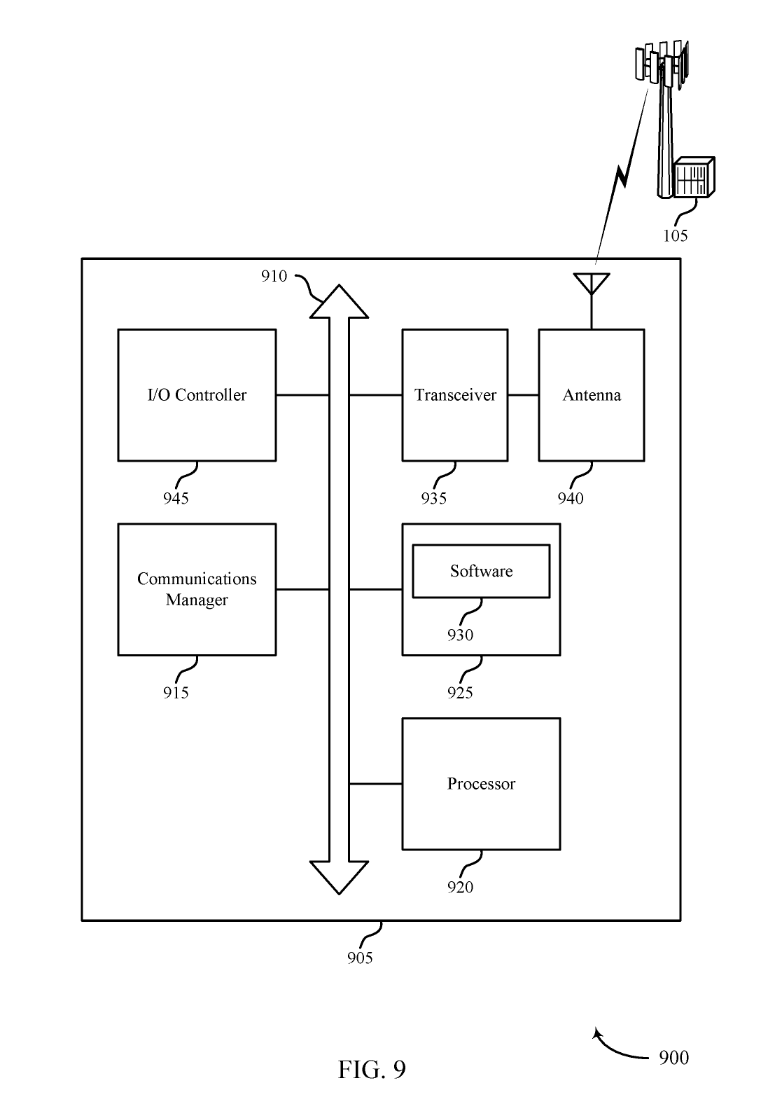

Receiver 610 may receive information such as packets, user data, or control information associated with various information channels (e.g., control channels, data channels, and information related to inter-rat mobility measurements and operations to support UE connectivity, etc.). Information may be passed on to other components of the device. The receiver 610 may be an example of aspects of the transceiver 935 described with reference to FIG. 9.

Communications manager 615 may be an example of aspects of the communications manager 915 described with reference to FIG. 9.

Communications manager 615 may measure a signal strength of a serving cell that is operating according to a first radio access technology (RAT), determine, based on the signal strength satisfying a first threshold, that an identifier associated with the serving cell is on a list of cells that indicates at least one prior measurement procedure has failed and a RLF condition resulted, modify a second threshold based on determining that the identifier associated with the serving cell is on the list, where the second threshold is different from the first threshold, and transmit a measurement report to a base station for the serving cell based on determining that the signal strength of the serving cell satisfies the second threshold for a predetermined time period.

Transmitter 620 may transmit signals generated by other components of the device. In some examples, the transmitter 620 may be collocated with a receiver 610 in a transceiver module. For example, the transmitter 620 may be an example of aspects of the transceiver 935 described with reference to FIG. 9. The transmitter 620 may include a single antenna, or it may include a set of antennas.

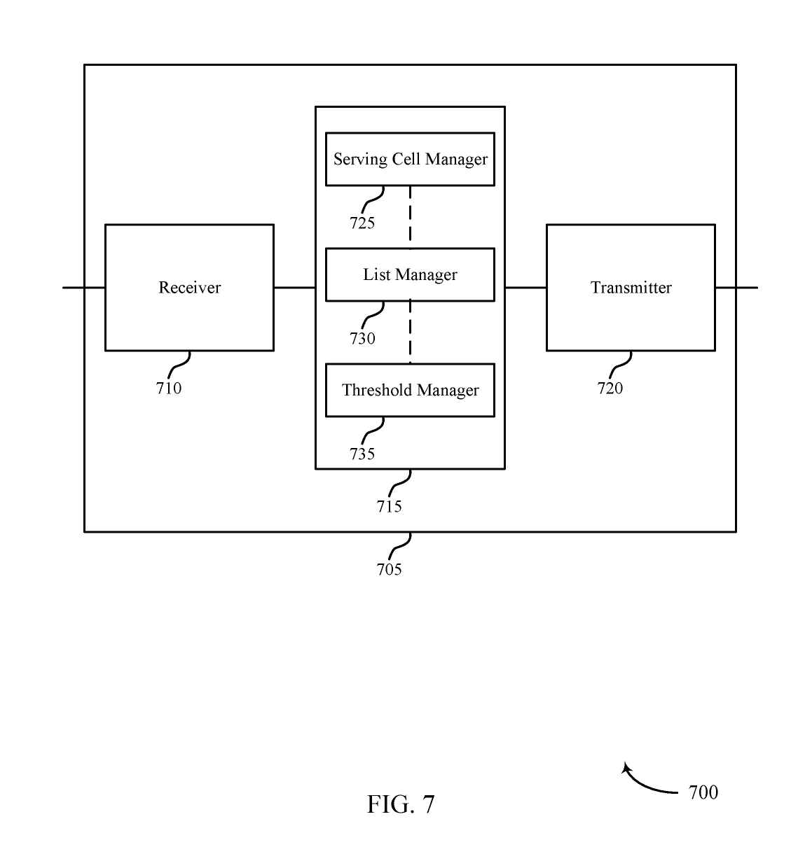

FIG. 7 shows a block diagram 700 of a wireless device 705 that supports inter-rat mobility measurements and operations to support UE connectivity in accordance with various aspects of the present disclosure. Wireless device 705 may be an example of aspects of a wireless device 605 or a UE 115 as described with reference to FIGS. 1 and 6. Wireless device 705 may include receiver 710, communications manager 715, and transmitter 720. Wireless device 705 may also include a processor. Each of these components may be in communication with one another (e.g., via one or more buses).

Receiver 710 may receive information such as packets, user data, or control information associated with various information channels (e.g., control channels, data channels, and information related to inter-rat mobility measurements and operations to support UE connectivity, etc.). Information may be passed on to other components of the device. The receiver 710 may be an example of aspects of the transceiver 935 described with reference to FIG. 9.

Communications manager 715 may be an example of aspects of the communications manager 915 described with reference to FIG. 9.

Communications manager 715 may also include serving cell manager 725, list manager 730, and threshold manager 735.

Serving cell manager 725 may measure a signal strength of a serving cell that is operating according to a first RAT, determine that the signal strength of the serving cell is below the second threshold for the predetermined time period, transmit a measurement report to a base station for the serving cell based on determining that the signal strength of the serving cell satisfies the second threshold for a predetermined time period, identify a condition of the signal strength of the serving cell that indicates a low signal to noise plus interface ratio (SINR), a fluctuating signal, or a fast fading signal, or any combination thereof, and determine that an RLF event occurred while communicating over the serving cell, where the measurement report includes a reference signal received power (RSRP) of the serving cell when the RLF event occurred or a location of the UE when the RLF event occurred, or both.

List manager 730 may determine, based on the signal strength satisfying a first threshold, that an identifier associated with the serving cell is on a list of cells that indicates at least one prior measurement procedure has failed and a RLF condition resulted and transmit an indication to the base station that the serving cell is on the list. In some cases, determining that the identifier is on the list further includes receiving an indication from the base station that the serving cell is on the list. In some examples, list manager 730 may update the list of cells based at least in part on a determination by the serving cell manager 725 that an RLF occurred while communicating over the serving cell.

Threshold manager 735 may modify a second threshold based on determining that the identifier associated with the serving cell is on the list, where the second threshold is different from the first threshold, modify the second threshold based on the location of the UE, adjust a value of a third threshold associated with the signal strength of the neighboring cell, and modify the second threshold based on identifying the condition. In some cases, modifying the second threshold further includes adjusting a value of the second threshold, where the value of the second threshold is less than a value of the first threshold. In some cases, modifying the second threshold further includes adjusting the second threshold according to an offset based on information included in the list associated with the identifier of the serving cell. In some cases, the offset is determined based on information included on the list related to a previous RLF event associated with the serving cell.

Transmitter 720 may transmit signals generated by other components of the device. In some examples, the transmitter 720 may be collocated with a receiver 710 in a transceiver module. For example, the transmitter 720 may be an example of aspects of the transceiver 935 described with reference to FIG. 9. The transmitter 720 may include a single antenna, or it may include a set of antennas.

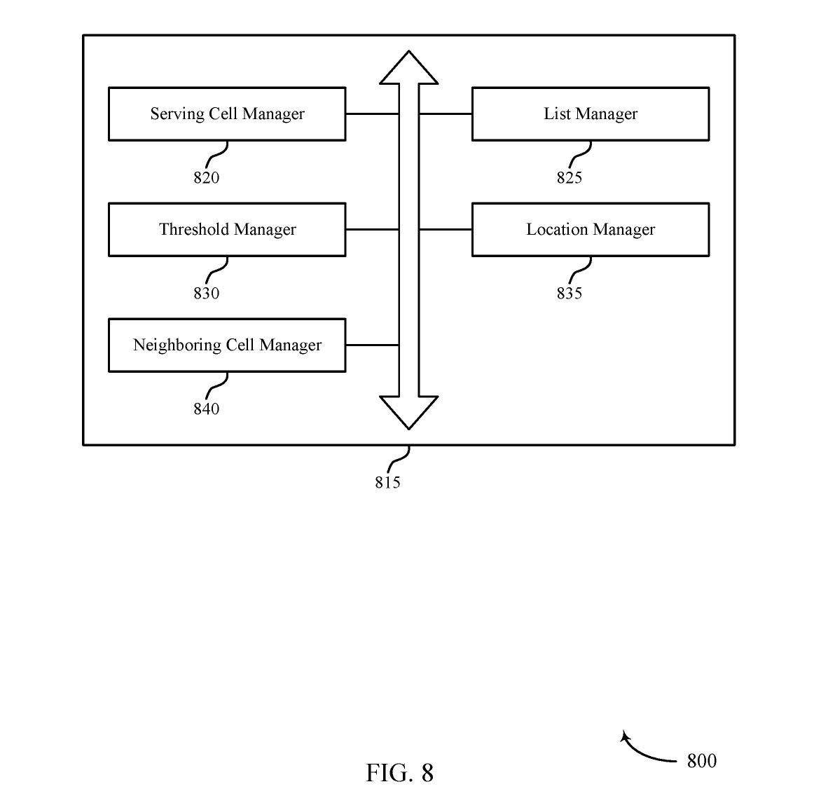

FIG. 8 shows a block diagram 800 of a communications manager 815 that supports inter-rat mobility measurements and operations to support UE connectivity in accordance with various aspects of the present disclosure. The communications manager 815 may be an example of aspects of a communications manager 615, a communications manager 715, or a communications manager 915 described with reference to FIGS. 6, 7, and 9. The communications manager 815 may include serving cell manager 820, list manager 825, threshold manager 830, location manager 835, and neighboring cell manager 840. Each of these modules may communicate, directly or indirectly, with one another (e.g., via one or more buses).

Serving cell manager 820 may measure a signal strength of a serving cell that is operating according to a first RAT, determine that the signal strength of the serving cell is below the second threshold for the predetermined time period, transmit a measurement report to a base station for the serving cell based on determining that the signal strength of the serving cell satisfies the second threshold for a predetermined time period, identify a condition of the signal strength of the serving cell that indicates a low signal to noise plus interface ratio (SINR), a fluctuating signal, or a fast fading signal, or any combination thereof, and determine that an RLF event occurred while communicating over the serving cell, where the measurement report includes a reference signal received power (RSRP) of the serving cell when the RLF event occurred or a location of the UE when the RLF event occurred, or both.

List manager 825 may determine, based on the signal strength satisfying a first threshold, that an identifier associated with the serving cell is on a list of cells that indicates at least one prior measurement procedure has failed and a RLF condition resulted and transmit an indication to the base station that the serving cell is on the list. In some cases, determining that the identifier is on the list further includes receiving an indication from the base station that the serving cell is on the list. In some examples, list manager 825 may update the list of cells based at least in part on a determination by the serving cell manager 820 that an RLF occurred while communicating over the serving cell.

Threshold manager 830 may modify a second threshold based on determining that the identifier associated with the serving cell is on the list, where the second threshold is different from the first threshold, modify the second threshold based on the location of the UE, adjust a value of a third threshold associated with the signal strength of the neighboring cell, and modify the second threshold based on identifying the condition. In some cases, modifying the second threshold further includes adjusting a value of the second threshold, where the value of the second threshold is less than a value of the first threshold. In some cases, modifying the second threshold further includes adjusting the second threshold according to an offset based on information included in the list associated with the identifier of the serving cell. In some cases, the offset is determined based on information included on the list related to a previous RLF event associated with the serving cell.

Location manager 835 may identify a location of the UE and compare the location of the UE to a location of a past RLF event associated with the serving cell, where the location of the past RLF event is included on the list.

Neighboring cell manager 840 may measure a signal strength of a neighboring cell, operating according to a second RAT that is different from the first RAT and determine that the signal strength of the neighboring cell is above a third threshold for the predetermined time period. In some cases, the second threshold is associated with an inter-RAT handover event between the serving cell and the neighboring cell.

FIG. 9 shows a diagram of a system 900 including a device 905 that supports inter-rat mobility measurements and operations to support UE connectivity in accordance with various aspects of the present disclosure. Device 905 may be an example of or include the components of wireless device 605, wireless device 705, or a UE 115 as described above, e.g., with reference to FIGS. 1, 6 and 7. Device 905 may include components for bi-directional voice and data communications including components for transmitting and receiving communications, including communications manager 915, processor 920, memory 925, software 930, transceiver 935, antenna 940, and I/O controller 945. These components may be in electronic communication via one or more busses (e.g., bus 910). Device 905 may communicate wirelessly with one or more base stations 105.

Processor 920 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (e.g., functions or tasks supporting inter-rat mobility measurements and operations to support UE connectivity).

Memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware and/or software operation such as the interaction with peripheral components or devices.

Software 930 may include code to implement aspects of the present disclosure, including code to support inter-rat mobility measurements and operations to support UE connectivity. Software 930 may be stored in a non-transitory computer-readable medium such as system memory or other memory. In some cases, the software 930 may not be directly executable by the processor but may cause a computer (e.g., when compiled and executed) to perform functions described herein.

Transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

In some cases, the wireless device may include a single antenna 940. However, in some cases the device may have more than one antenna 940, which may be capable of concurrently transmitting or receiving multiple wireless transmissions.

I/O controller 945 may manage input and output signals for device 905. I/O controller 945 may also manage peripherals not integrated into device 905. In some cases, I/O controller 945 may represent a physical connection or port to an external peripheral. In some cases, I/O controller 945 may utilize an operating system such as iOS®, ANDROID®, MS-DOS®, MS-WINDOWS®, OS/2®, UNIX®, LINUX®, or another known operating system.

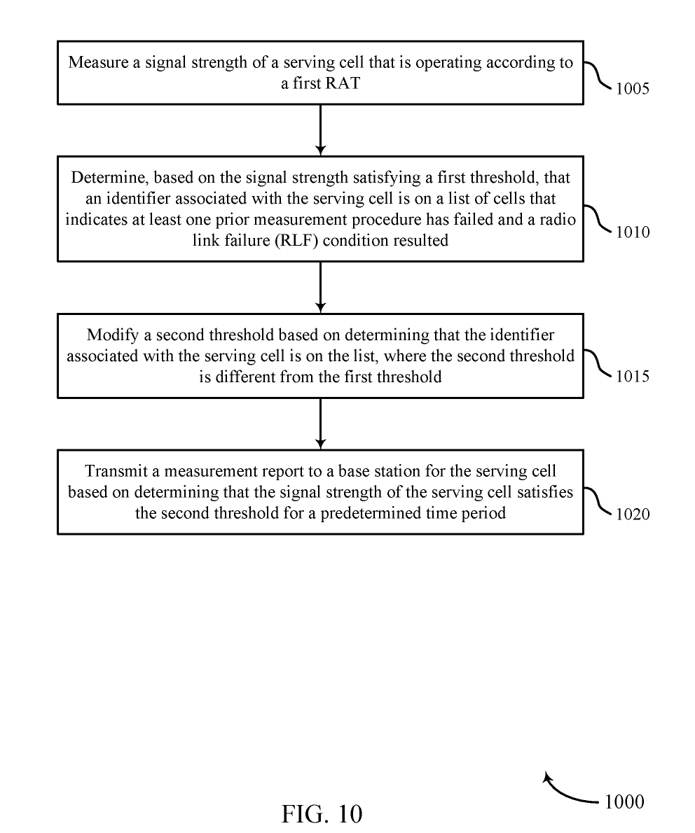

FIG. 10 shows a flowchart illustrating a method 1000 for inter-rat mobility measurements and operations to support UE connectivity in accordance with various aspects of the present disclosure. The operations of method 1000 may be implemented by a UE 115 or its components as described herein. For example, the operations of method 1000 may be performed by a communications manager as described with reference to FIGS. 6 through 9. In some examples, a UE 115 may execute a set of codes to control the functional elements of the device to perform the functions described below. Additionally or alternatively, the UE 115 may perform aspects the functions described below using special-purpose hardware.

At block 1005, the UE 115 may measure a signal strength of a serving cell that is operating according to a first radio access technology (RAT). The operations of block 1005 may be performed according to the methods described with reference to FIGS. 1 through 5. In certain examples, aspects of the operations of block 1005 may be performed by a serving cell manager as described with reference to FIGS. 6 through 9.

At block 1010, the UE 115 may determine, based at least in part on the signal strength satisfying a first threshold, that an identifier associated with the serving cell is on a list of cells that indicates at least one prior measurement procedure has failed and a radio link failure (RLF) condition resulted. The operations of block 1010 may be performed according to the methods described with reference to FIGS. 1 through 5. In certain examples, aspects of the operations of block 1010 may be performed by a list manager as described with reference to FIGS. 6 through 9.

At block 1015, the UE 115 may modify a second threshold based at least in part on determining that the identifier associated with the serving cell is on the list, wherein the second threshold is different from the first threshold. The operations of block 1015 may be performed according to the methods described with reference to FIGS. 1 through 5. In certain examples, aspects of the operations of block 1015 may be performed by a threshold manager as described with reference to FIGS. 6 through 9.

At block 1020, the UE 115 may transmit a measurement report to a base station for the serving cell based at least in part on determining that the signal strength of the serving cell satisfies the second threshold for a predetermined time period. The operations of block 1020 may be performed according to the methods described with reference to FIGS. 1 through 5. In certain examples, aspects of the operations of block 1020 may be performed by a serving cell manager as described with reference to FIGS. 6 through 9.

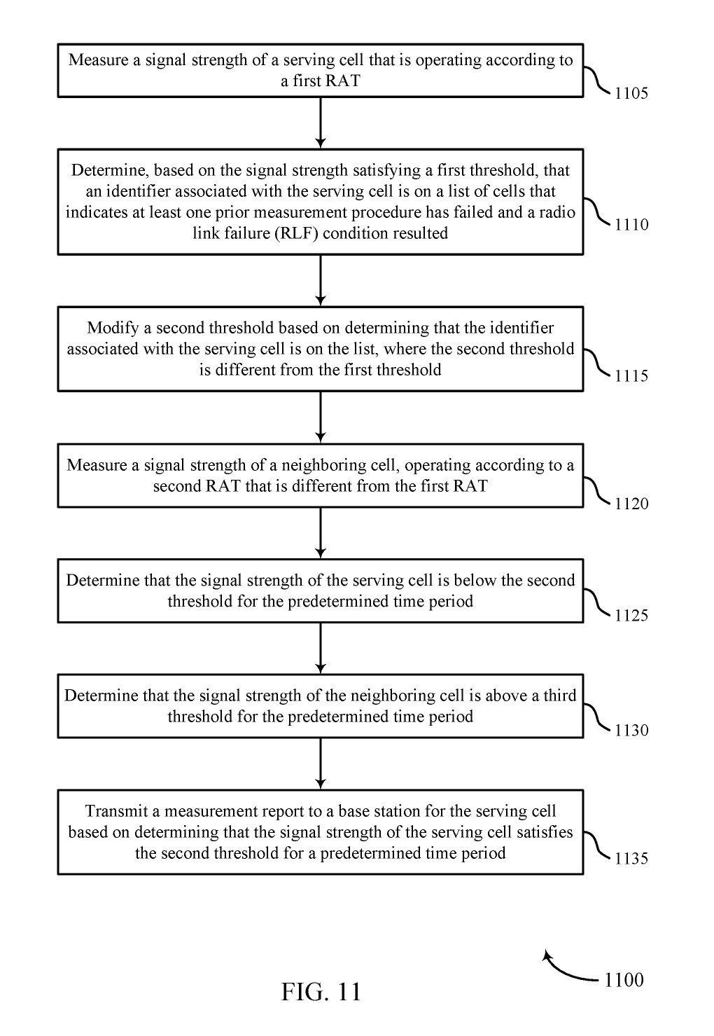

FIG. 11 shows a flowchart illustrating a method 1100 for inter-rat mobility measurements and operations to support UE connectivity in accordance with various aspects of the present disclosure. The operations of method 1100 may be implemented by a UE 115 or its components as described herein. For example, the operations of method 1100 may be performed by a communications manager as described with reference to FIGS. 6 through 9. In some examples, a UE 115 may execute a set of codes to control the functional elements of the device to perform the functions described below. Additionally or alternatively, the UE 115 may perform aspects the functions described below using special-purpose hardware.

At block 1105, the UE 115 may measure a signal strength of a serving cell that is operating according to a first radio access technology (RAT). The operations of block 1105 may be performed according to the methods described with reference to FIGS. 1 through 5. In certain examples, aspects of the operations of block 1105 may be performed by a serving cell manager as described with reference to FIGS. 6 through 9.

At block 1110, the UE 115 may determine, based at least in part on the signal strength satisfying a first threshold, that an identifier associated with the serving cell is on a list of cells that indicates at least one prior measurement procedure has failed and a radio link failure (RLF) condition resulted. The operations of block 1110 may be performed according to the methods described with reference to FIGS. 1 through 5. In certain examples, aspects of the operations of block 1110 may be performed by a list manager as described with reference to FIGS. 6 through 9.

At block 1115, the UE 115 may modify a second threshold based at least in part on determining that the identifier associated with the serving cell is on the list, wherein the second threshold is different from the first threshold. The operations of block 1115 may be performed according to the methods described with reference to FIGS. 1 through 5. In certain examples, aspects of the operations of block 1115 may be performed by a threshold manager as described with reference to FIGS. 6 through 9.

At block 1120, the UE 115 may measure a signal strength of a neighboring cell, operating according to a second RAT that is different from the first RAT. The operations of block 1120 may be performed according to the methods described with reference to FIGS. 1 through 5. In certain examples, aspects of the operations of block 1120 may be performed by a neighboring cell manager as described with reference to FIGS. 6 through 9.

At block 1125, the UE 115 may determine that the signal strength of the serving cell is below the second threshold for the predetermined time period. The operations of block 1125 may be performed according to the methods described with reference to FIGS. 1 through 5. In certain examples, aspects of the operations of block 1125 may be performed by a serving cell manager as described with reference to FIGS. 6 through 9.

At block 1130, the UE 115 may determine that the signal strength of the neighboring cell is above a third threshold for the predetermined time period. The operations of block 1130 may be performed according to the methods described with reference to FIGS. 1 through 5. In certain examples, aspects of the operations of block 1130 may be performed by a neighboring cell manager as described with reference to FIGS. 6 through 9.

At block 1135, the UE 115 may transmit a measurement report to a base station for the serving cell based at least in part on determining that the signal strength of the serving cell satisfies the second threshold for a predetermined time period. The operations of block 1135 may be performed according to the methods described with reference to FIGS. 1 through 5. In certain examples, aspects of the operations of block 1135 may be performed by a serving cell manager as described with reference to FIGS. 6 through 9.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communication systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM).

An orthogonal frequency division multiple access (OFDMA) system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunication system (UMTS). 3GPP Long Term Evolution (LTE) and LTE-Advanced (LTE-A) are releases of Universal Mobile Telecommunication system (UMTS) that use E-UTRA. UTRA, E-UTRA, UMTS, LTE, LTE-A, and Global System for Mobile communications (GSM) are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE system may be described for purposes of example, and LTE terminology may be used in much of the description, the techniques described herein are applicable beyond LTE applications.

In LTE/LTE-A networks, including such networks described herein, the term evolved node B (eNB) may be generally used to describe the base stations. The wireless communication system or systems described herein may include a heterogeneous LTE/LTE-A network in which different types of evolved node B (eNBs) provide coverage for various geographical regions. For example, each eNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communication system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communication system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communication system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a non-transitory computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method performed by a user equipment (UE) in a wireless communication system, comprising:
measuring a signal strength of a serving cell that is operating according to a first radio access technology (RAT);
determining, based at least in part on the signal strength satisfying a first threshold, that an identifier associated with the serving cell is on a list of cells for which at least one prior measurement procedure has failed and a radio link failure (RLF) condition resulted;
modifying a second threshold based at least in part on determining that the identifier associated with the serving cell is on the list of cells, wherein the second threshold is different from the first threshold; and
transmitting a measurement report to a base station for the serving cell based at least in part on determining that the signal strength of the serving cell satisfies the second threshold for a predetermined time period.

2. The method of claim 1, further comprising:
identifying a location of the UE; and
modifying the second threshold based at least in part on the location of the UE.

3. The method of claim 2, further comprising:
comparing the location of the UE to a location of a past RLF event associated with the serving cell, wherein the location of the past RLF event is included on the list of cells.

4. The method of claim 1, further comprising:
measuring a signal strength of a neighboring cell operating according to a second RAT that is different from the first RAT.

5. The method of claim 4, wherein the second threshold is associated with an inter-RAT handover event between the serving cell and the neighboring cell.

6. The method of claim 4, further comprising:
determining that the signal strength of the serving cell is below the second threshold for the predetermined time period; and
determining that the signal strength of the neighboring cell is above a third threshold for the predetermined time period.

7. The method of claim 4, wherein modifying the second threshold further comprises:
adjusting a value of the second threshold, wherein the value of the second threshold is less than a value of the first threshold; and
the method further comprising adjusting a value of a third threshold associated with the signal strength of the neighboring cell.

8. The method of claim 1, wherein modifying the second threshold further comprises:
adjusting the second threshold according to an offset based at least in part on information included in the list of cells and associated with the identifier of the serving cell.

9. The method of claim 8, wherein the offset is determined based at least in part on information included on the list of cells and related to a previous RLF event associated with the serving cell.

10. The method of claim 1, further comprising:
transmitting an indication to the base station that the serving cell is on the list of cells.

11. The method of claim 1, further comprising:
identifying a condition of the signal strength of the serving cell that indicates a low signal to noise plus interface ratio (SINK), a fluctuating signal, or a fast fading signal, or any combination thereof; and
modifying the second threshold based at least in part on identifying the condition.

12. The method of claim 1, wherein determining that the identifier is on the list of cells further comprises:
receiving an indication from the base station that the serving cell is on the list of cells.

13. The method of claim 1, further comprising:
determining that a RLF event occurred while communicating over the serving cell, wherein the measurement report includes a reference signal received power (RSRP) of the serving cell when the RLF event occurred or a location of the UE when the RLF event occurred, or both; and
updating the list of cells based at least in part on determining that the RLF event occurred.

14. A user equipment (UE), comprising:
a processor;
memory in electronic communication with the processor; and
instructions stored in the memory and operable, when executed by the processor, to cause the UE to:
measure a signal strength of a serving cell that is operating according to a first radio access technology (RAT);
determine, based at least in part on the signal strength satisfying a first threshold, that an identifier associated with the serving cell is on a list of cells for which at least one prior measurement procedure has failed and a radio link failure (RLF) condition resulted;
modify a second threshold based at least in part on determining that the identifier associated with the serving cell is on the list of cells, wherein the second threshold is different from the first threshold; and
transmit a measurement report to a base station for the serving cell based at least in part on determining that the signal strength of the serving cell satisfies the second threshold for a predetermined time period.

15. The UE of claim 14, wherein the instructions are further executable by the processor to cause the UE to:
identify a location of the UE; and
modify the second threshold based at least in part on the location of the UE.

16. The UE of claim 14, wherein the instructions are further executable by the processor to cause the UE to:
measure a signal strength of a neighboring cell that operates according to a second RAT that is different from the first RAT.

17. The UE of claim 16, wherein the second threshold is associated with an inter-RAT handover event between the serving cell and the neighboring cell.

18. The UE of claim 16, wherein the instructions are further executable by the processor to cause the UE to:
determine that the signal strength of the serving cell is below the second threshold for the predetermined time period; and
determine that the signal strength of the neighboring cell is above a third threshold for the predetermined time period.

19. The UE of claim 14, wherein the instructions are further executable by the processor to cause the UE to:
adjust the second threshold according to an offset based at least in part on information included in the list of cells and associated with the identifier of the serving cell.

20. An apparatus for wireless communication, comprising:
means for measuring a signal strength of a serving cell that is operating according to a first radio access technology (RAT);
means for determining, based at least in part on the signal strength satisfying a first threshold, that an identifier associated with the serving cell is on a list of cells for which at least one prior measurement procedure has failed and a radio link failure (RLF) condition resulted;
means for modifying a second threshold based at least in part on determining that the identifier associated with the serving cell is on the list of cells, wherein the second threshold is different from the first threshold; and
means for transmitting a measurement report to a base station for the serving cell based at least in part on determining that the signal strength of the serving cell satisfies the second threshold for a predetermined time period.
